(19) United States
(12) Patent Application Publication
(10) Pub. No.: US 2023/0023447 A1
(43) Pub. Date: Jan. 26, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Yutaka KOBAYASHI, Mie (JP); Daisuke SAITO, Mie (JP); Masanori MORIYASU, Mie (JP); Shinji TANAKA, Mie (JP)

(21) Appl. No.: 17/780,889

(22) PCT Filed: Nov. 11, 2020
(86) PCT No.: PCT/JP2020/041992

§ 371 Date: May 27, 2022

(30) Foreign Application Priority Data
Dec. 2, 2019 (JP) 2019-217842

(51) Int. Cl. H01R 12/72

(52) U.S. Cl. CPC H01R 12/721; H01R 12/725

(57) ABSTRACT

A connector is provided with a housing into which a terminal fitting is inserted, and a retainer to be mounted into the housing. The retainer includes a rear stop portion for restricting a rearward movement of the terminal fitting and a front stop portion for restricting a forward movement of the terminal fitting.

### TECHNICAL FIELD

The present disclosure relates to a connector.

### BACKGROUND

A connector described in Patent Document 1 includes a board accommodating member for accommodating a circuit board and a terminal accommodating member for accommodating terminals. A board insertion portion is provided to be open in the front surface of the terminal accommodating member. When the board accommodating member and the terminal accommodating member are fit, the circuit board is inserted into the board insertion portion and terminal portions provided on a plate surface of the circuit board and contact portions of the terminals are brought into contact.

A retainer is inserted into the terminal accommodating member through a retainer insertion opening. Small projections of the retainer abut on the terminal fittings from behind and the terminal fittings are restricted from coming out rearward.

### PRIOR ART DOCUMENT

### Patent Document

Patent Document 1: JP 2017-084570 A

### SUMMARY OF THE INVENTION

### Problems to be Solved

In the case of Patent Document 1, a forward inserting operation of the terminal fitting is stopped by the terminal fitting abutting on a front surface side of the terminal accommodating member. However, since the board insertion portion is provided on the front surface side of the terminal accommodating member, it is difficult to ensure strength sufficient to restrict the inserting operation of the terminal fitting. Further, the terminal fitting may fall into the board insertion portion. Thus, the terminal fitting may not stop at a proper insertion position with respect to the terminal accommodating member.

Accordingly, the present disclosure aims to provide a connector with high reliability in stopping a terminal fitting at an insertion position.

### Means to Solve the Problem

The present disclosure is directed to a connector with a terminal fitting, a housing configured such that the terminal fitting is inserted thereinto, and a retainer to be mounted into the housing, the retainer including a rear stop portion for restricting a rearward movement of the terminal fitting and a front stop portion for restricting a forward movement of the terminal fitting.

### Effect of the Invention

According to the present disclosure, it is possible to provide a connector with high reliability in stopping a terminal fitting at an insertion position.

### BRIEF DESCRIPTION OF THE DRAWINGS

FIG. 1 is an exploded perspective view of a connector.

FIG. 2 is a side view in section showing a state where the connector is connected to a mating connector and a terminal fitting is connected to a circuit board at a connection position.

FIG. 3 is a side view in section showing a state where a retainer is at a partial locking position, a connecting member abuts on a front stop portion of the retainer at a protection position and a resilient contact portion is protected by a protecting member before the connector is connected to the mating connector.

FIG. 4 is a side view in section showing a state where the retainer has moved to a full locking position from the state of FIG. 3.

FIG. 5 is a section along A-A of FIG. 3.

FIG. 6 is a section along B-B of FIG. 4.

FIG. 7 is an enlarged section along C-C of FIG. 5 showing a main part.

FIG. 8 is an enlarged section along D-D of FIG. 6 showing a main part.

FIG. 9 is an enlarged front view showing a state where a cam surface is exposed toward a front surface side of a housing through a window portion when the retainer is at the partial locking position.

FIG. 10 is an enlarged front view showing a state where the cam surface is retracted from the window portion and arranged inside the housing when the retainer is at the full locking position.

FIG. 11 is a perspective view of a terminal fitting.

FIG. 12 is a front view of an outer housing.

FIG. 13 is a front view of the retainer.

FIG. 14 is a back view of the retainer.

### DETAILED DESCRIPTION TO EXECUTE THE INVENTION

### Description of Embodiments of Present Disclosure

First, embodiments of the present disclosure are listed and described.

(1) The connector of the present disclosure is provided with a terminal fitting, a housing configured such that the terminal fitting is inserted thereinto, and a retainer to be mounted into the housing, the retainer including a rear stop portion for restricting a rearward movement of the terminal fitting and a front stop portion for restricting a forward movement of the terminal fitting. According to this configuration, since the front stop portion of the retainer restricts a forward movement of the terminal fitting, a structure equivalent to the front stop portion can be omitted from the housing or a structure equivalent to the front stop portion and provided in the housing can be simplified. Particularly, a forward movement of the terminal fitting can be restricted also when it is difficult to provide a structure equivalent to the front stop portion in the housing. As a result, reliability in stopping the terminal fitting at an insertion position can be enhanced.

(2) Preferably, the retainer is displaceable to a partial locking position and a full locking position with respect to the housing, the rear stop portion restricts a rearward movement of the terminal fitting at the full locking position, and the front stop portion restricts a forward movement of the terminal fitting at the partial locking position. According to this configuration, a change can be made from a state where a forward movement of the terminal fitting is restricted to a state where a rearward movement of the terminal fitting is restricted by a displacement operation of the retainer.

(3) The terminal fitting may include a connecting member and a protecting member, the connecting member may be displaceable with respect to the protecting member to a protection position where the connecting member is protected by the protecting member and a connection position where the connecting member is connected to a circuit board, the connection position being forward of the protection position, and the connecting member may be configured to abut on the front stop portion at the protection position when the retainer is at the partial locking position. According to this configuration, since the front stop portion of the retainer restricts a forward movement of the connecting member, the connecting member can be prevented from being inadvertently displaced from the protection position to the connection position with respect to the protecting member. As a result, a state where the connecting member is protected by the protecting member at the protection position can be satisfactorily realized.

(4) The retainer may have a cam surface inclined with respect to a front-rear direction on a front surface side, and the cam surface may be arranged to be exposed to a front surface side of the housing at the partial locking position. According to this configuration, the retainer can be displaced toward the full locking position only by applying a pressing force to the cam surface from the front surface side of the housing when the retainer is at the partial locking position. Thus, a complicated operation needs not be performed in displacing the retainer to the full locking position and workability can be improved.

### Details of Embodiment of Present Disclosure

A specific example of a connector of the present disclosure is described below with reference to the drawings. Note that the present invention is not limited to this illustration and is intended to be represented by claims and include all changes in the scope of claims and in the meaning and scope of equivalents.

<Basic Structure>

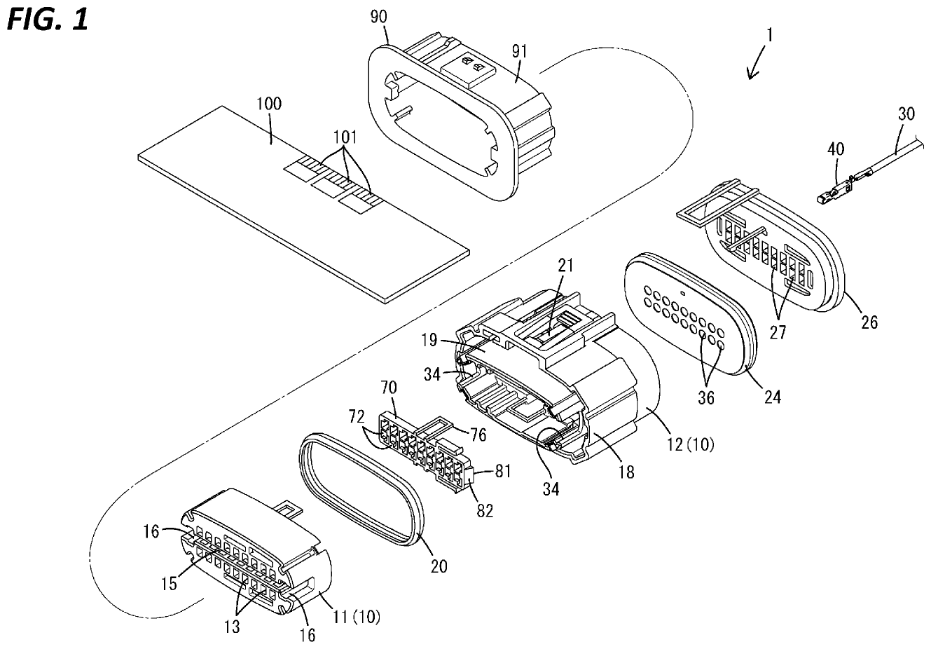

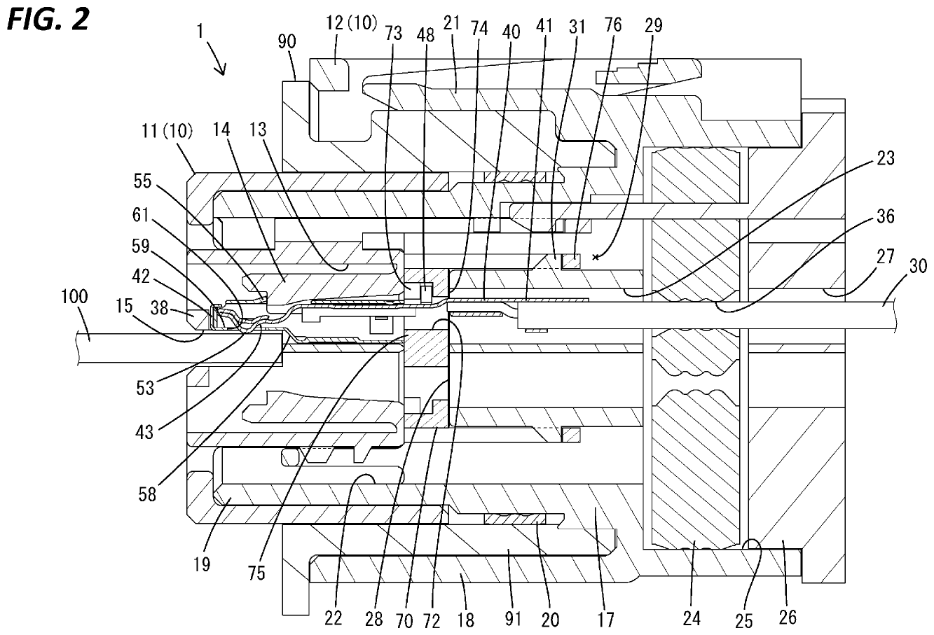

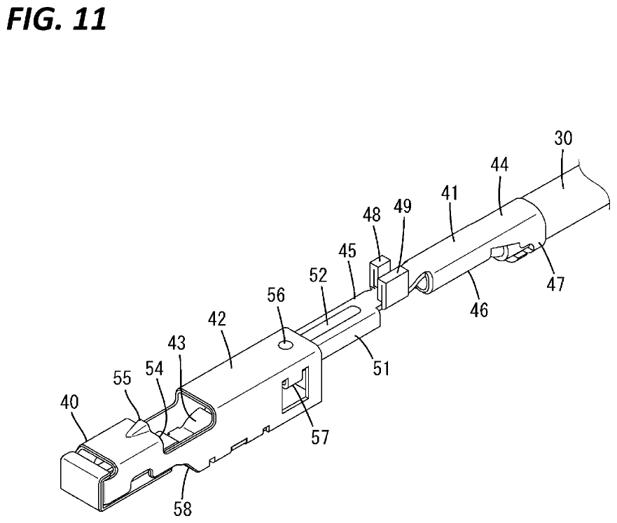

A connector 1 of the present disclosure includes, as shown in FIG. 1, a housing 10, terminal fittings 40 and a retainer 70. The housing 10 is made of synthetic resin and includes an inner housing 11 and an outer housing 12. The terminal fitting 40 is a plate member made of metal and includes, as shown in FIG. 11, a connecting member 41 and a protecting member 42. The retainer 70 is a single member made of synthetic resin. As shown in FIG. 2, the connecting member 41 is held in the outer housing 12 by the retainer 70. The protecting member 42 is held in the inner housing 11. The housing 10 is connected to a mating connector 90. The mating connector 90 is fixed to an unillustrated case. A circuit board 100 is installed in the case. The connecting member 41 is electrically connected to the circuit board 100.

<Housing>

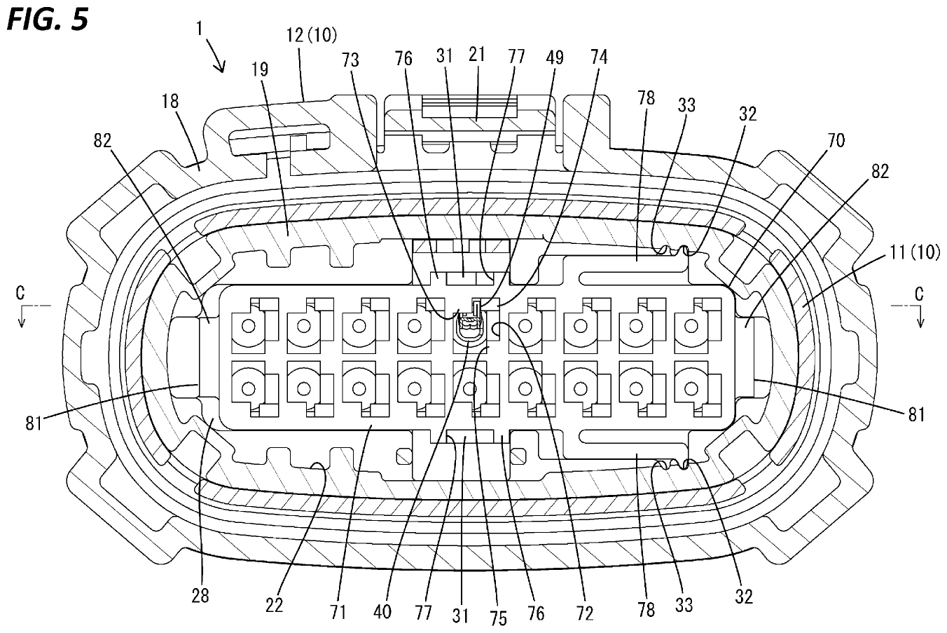

As shown in FIG. 2, the housing 10 is configured by assembling the inner housing 11 in a front part of the outer housing 12. The inner housing 11 has a flat shape long in a width direction as a whole as shown in FIG. 5. As shown in FIG. 1, the inner housing 11 includes a plurality of front cavities 13. A plurality of the front cavities 13 are arranged side by side in the width direction in each of two stages in a vertical direction.

As shown in FIG. 2, the inner housing 11 includes a plurality of locking lances 14 at positions corresponding to the respective front cavities 13. Each locking lance 14 extends forward from an inner wall surface (upper surface of the front cavity 13 in the upper stage, lower surface of the front cavity 13 in the lower stage) of each front cavity 13, and is shaped to project into the front cavity 13. The protecting member 42 is inserted into each front cavity 13. The protecting member 42 is resiliently locked by the locking lance 14 and held in the inner housing 11.

The inner housing 11 includes a board insertion portion 15 capable of accommodating the circuit board 100 in a vertically central part between the respective upper and lower front cavities 13. As shown in FIG. 1, the board insertion portion 15 is in the form of a slit groove along the width direction and open in the front surface and both side surfaces of the inner housing 11. The board insertion portion 15 communicates with each of the upper and lower front cavities 13 in the inner housing 11.

The inner housing 11 includes a pair of window portions 16 in vertically central parts of both side surfaces (side surfaces on both widthwise sides) as shown in FIG. 1. Each window portion 16 is in the form of a recessed groove extending in the front-rear direction and open on a front end. The inside of each window portion 16 communicates with the board insertion portion 15.

The outer housing 12 includes a housing body 17, a fitting tube portion 18 surrounding the outer periphery of the housing body 17 and an inner tube portion 19 projecting forward from the housing body 17 as shown in FIG. 2. A sealing ring 20 is mounted on the outer periphery of the housing body 17. A receptacle 91 of the mating connector 90 is fit between the housing body 17 and the fitting tube portion 18. The sealing ring 20 is sandwiched between the receptacle 91 and the housing body 17 to seal between the housing 10 and the mating connector 90 in a liquid-tight manner. A lock arm 21 is provided on the upper wall of the fitting tube portion 18. The lock arm 21 locks the receptacle 91 of the mating connector 90 and holds the housing 10 and the mating connector 90 in a fit state.

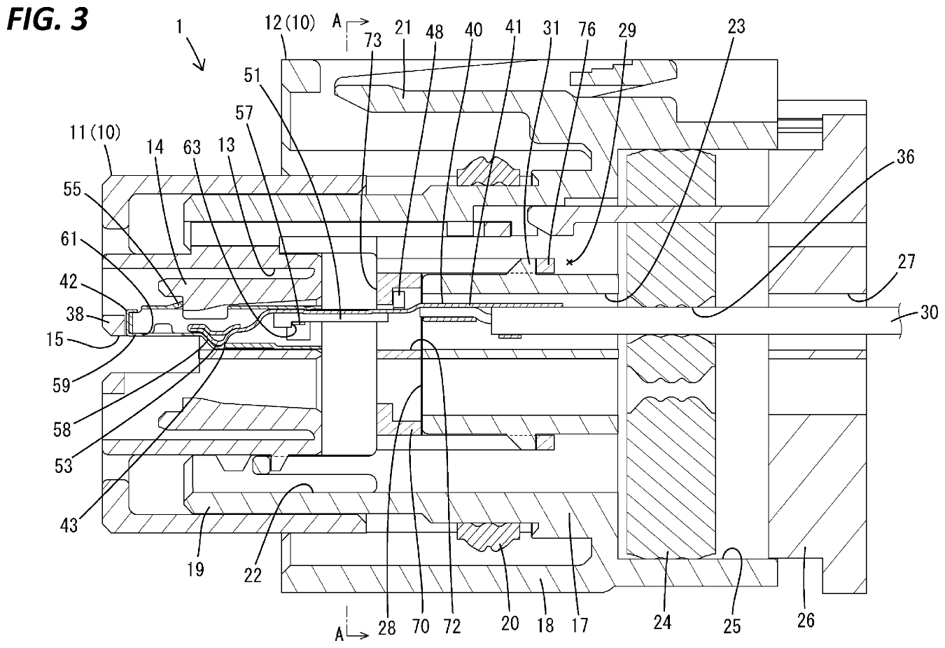

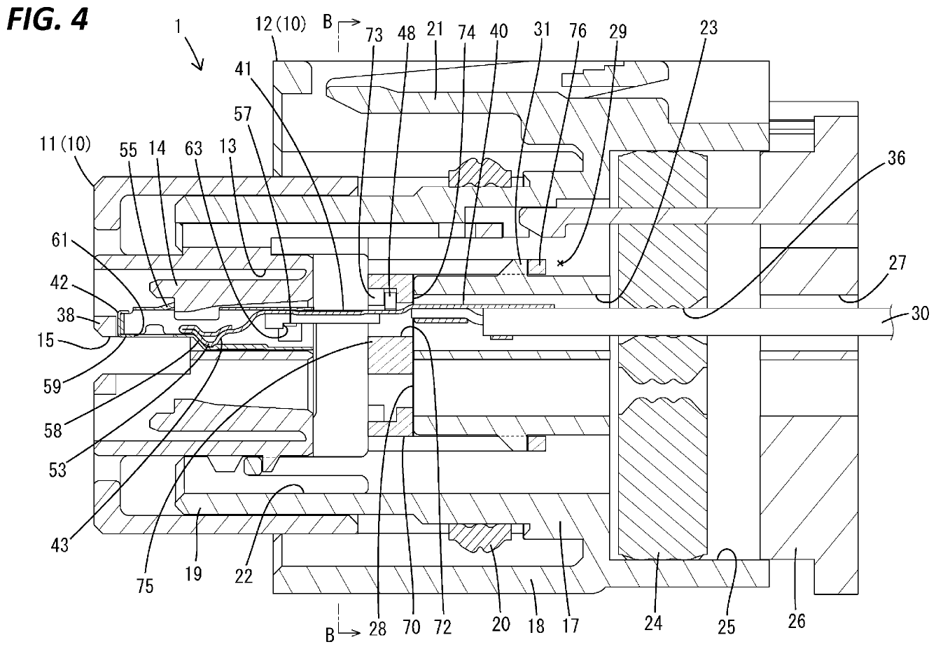

The outer housing 12 includes an inner fitting portion 22 in front of the housing body 17 and inside the inner tube portion 19. The inner housing 11 is fittable to the inner fitting portion 22. The inner housing 11 is movable with respect to the outer housing 12 to an initial position (see FIGS. 3 and 4) where the inner housing 11 is lightly fit to the inner fitting portion 22 and a fitting position (see FIG. 2) which is relatively receded from the initial position and where the inner housing 11 is deeply fit to the inner fitting portion 22. A forward projecting amount of the inner housing 11 from the outer housing 12 decreases as the inner housing 11 moves from the initial position to the fitting position. The inner housing 11 and the outer housing 12 are provided with a lock structure for holding the inner housing 11 respectively at the initial position and the fitting position. When the housing 10 is connected to the mating connector 90, a holding state by the lock structure is released by a lock releasing structure provided in the mating connector 90 and a displacement operation of the inner housing 11 is enabled.

As shown in FIG. 2, the housing body 17 includes a plurality of rear cavities 23 at positions communicating with the respective front cavities 13 via the inner fitting portion 22. A rear part of the connecting member 41 is inserted into each rear cavity 23.

A one-piece rubber plug 24 is mounted in a rear part of the housing body 17. The one-piece rubber plug 24 is made of rubber such as silicon rubber and accommodated into an accommodating portion 25 open in the rear surface of the housing body 17. The one-piece rubber plug 24 includes a plurality of sealing holes 36 at positions communicating with the respective rear cavities 23. A wire 30 connected to the connecting member 41 is inserted into each sealing hole 36 of the one-piece rubber plug 24 in a liquid-tight manner.

A rear holder 26 is accommodated into the accommodating portion 25 of the housing body 17, following the one-piece rubber plug 24. The rear holder 26 is held in the housing body 17. The one-piece rubber plug 24 is restricted from coming out from the accommodating portion 25 by the rear holder 26. The rear holder 26 includes a plurality of insertion holes 27 at positions communicating with the respective sealing holes 36. The wire 30 is inserted with play into each insertion hole 27 of the rear holder 26.

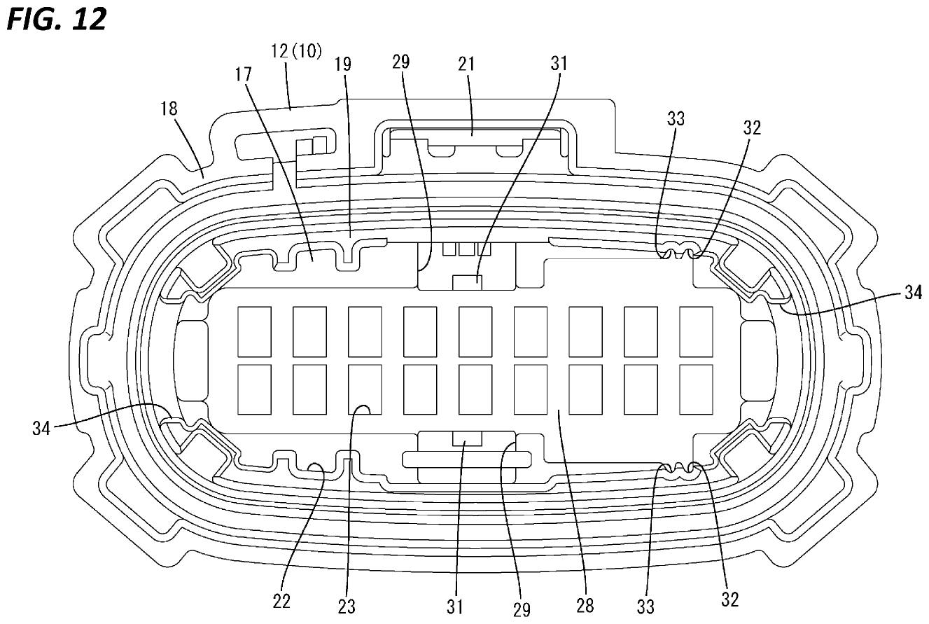

As shown in FIG. 12, the housing body 17 has a retainer mounting surface 28 on a front surface (surface facing the inner fitting portion 22). The retainer mounting surface 28 is a wall surface along the width direction and vertical direction. The front end of each rear cavity 28 is open in the retainer mounting surface 28. The retainer 70 is displaceable to a partial locking position and a full locking position along the retainer mounting surface 28. The housing body 17 includes space portions 29 for allowing the mounting of the retainer 70 in upper and lower end parts across the respective rear cavities 23. The space portions 29 penetrate in the front-rear direction in widthwise central parts of the upper and lower end parts of the housing body 17 and communicate with the inner fitting portion 22 and the accommodating portion 25.

The housing body 17 includes a pair of upper and lower projections 31 on the inner side surfaces (wall surfaces near a vertical center of the housing body 17) of the respective space portions 29. Each projection 31 is lockable to a later-described retaining portion 76 of the retainer 70 as shown in FIG. 2.

As shown in FIG. 12, the inner tube portion 19 includes a partial lock receiving portion 32 and a full lock receiving portion 33 on one widthwise side (right side of FIG. 12) of each of upper and lower inner surfaces facing the inner fitting portion 22. The partial lock receiving portion 32 and the full lock receiving portion 33 are both in the form of a recessed groove extending in the front-rear direction and open on the front end of the inner tube portion 19. The partial lock receiving portion 32 and the full lock receiving portion 33 are provided side by side in the width direction. The partial lock receiving portion 32 and the full lock receiving portion 33 are lockable to a later-described locking portion 78 of the retainer 70.

The inner tube portion 19 includes a pair of recesses 34 open on a front end on both side walls (side walls on both widthwise sides). If the inner housing 11 is inserted into the inner fitting portion 22, the recesses 34 are arranged to communicate with the window portions 16. Note that the front end of the inner tube portion 19 is arranged forward of the front end of the fitting tube portion 18.

<Terminal Fittings>

As shown in FIG. 11, the terminal fitting 40 is configured by arranging the protecting member 42 on a front part of the connecting member 41. The connecting member 41 is displaceable in the front-rear direction to a protection position (see FIGS. 3, 4 and 11) and a connection position (see FIG. 2) with respect to the protecting member 42.

The connecting member 41 is formed into a shape elongated in the front-rear direction by bending one metal plate. The connecting member 41 includes a resilient contact portion 43 in a front part, a wire connecting portion 44 in a rear part and a base portion 45 between the resilient contact portion 43 and the wire connecting portion 44.

The wire connecting portion 44 includes a wire barrel portion 46 in a front part and an insulation barrel portion 47 in a rear part as shown in FIG. 11. The insulation barrel portion 47 is in the form of an open barrel and configured to have a shorter front-rear dimension than the wire barrel portion 46. The wire barrel portion 46 is in the form of an open barrel and crimped and connected to a conductor part (core) of the wire 30. The insulation barrel portion 47 is crimped and connected to an insulation coating of the wire 30.

The base portion 45 is in the form of a strip extending in the front-rear direction and having plate surfaces extending along the width direction.

The connecting member 41 includes a pair of projecting pieces 48, 49 projecting upward from both widthwise ends of a rear end part of the base portion 45. Each projecting piece 48, 49 has a function as a stabilizer for guiding an inserting operation of the terminal fitting 40 into the housing 10.

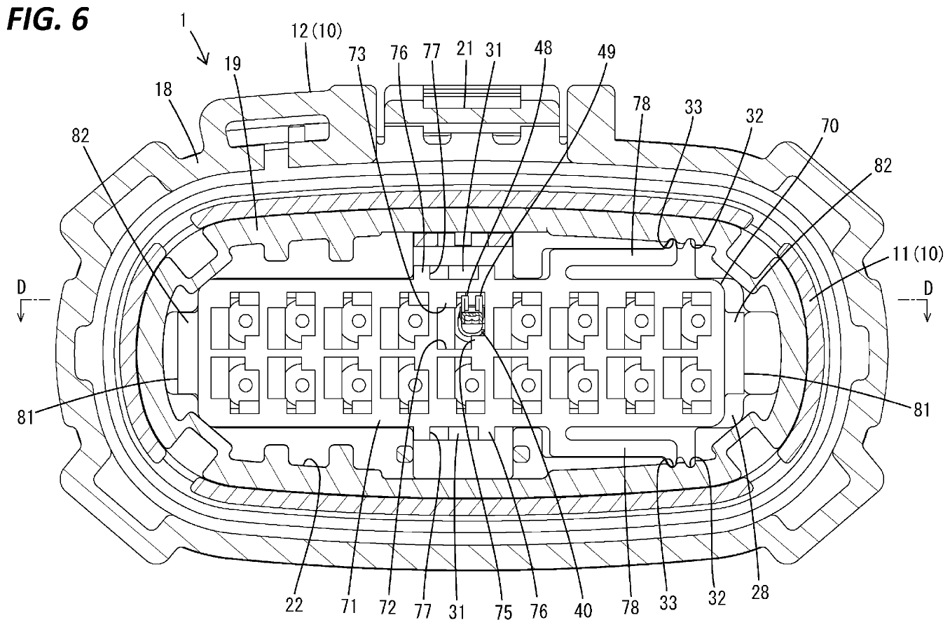

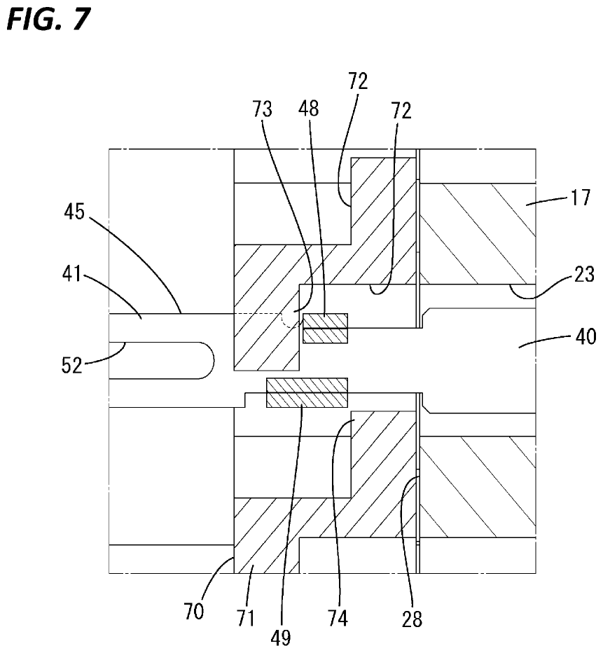

Each projecting piece 48, 49 has a double plate structure by being folded at an upper end. The front and rear ends of each projecting piece 48, 49 are arranged upright along the vertical direction. Out of the projecting pieces 48, 49, one projecting piece (projecting piece on a left side of FIG. 11, referred to as a first projecting piece 48 hereinafter) is shorter in the front-rear direction than the other projecting piece (projecting piece on a right side of FIG. 11, referred to as a second projecting piece 49 hereinafter). In particular, as shown in FIG. 7, the front end of the first projecting piece 48 is arranged behind that of the second projecting piece 49, and the rear end of the first projecting piece 48 is arranged at the same position as that of the second projecting piece 49 in the front-rear direction. As shown in FIG. 6, the upper end of the first projecting piece 48 is arranged at the same height position as that of the second projecting piece 49.

As shown in FIG. 11, the connecting member 41 includes a pair of side portions 51 (only one side portion 51 is shown in FIG. 11) projecting downward from both widthwise ends of the base portion 45 in front of the respective projecting pieces 48, 49. The both side portions 51 are shaped to have plate surfaces extending along the height vertical direction and extend in the front-rear direction. An intermediate part in the front-rear direction of the connecting member 41 has a gate-shaped cross-section by having the base portion 45 and the both side portions 51. A step portion 63 is provided on a front end lower part of the side portion 51.

The connecting member 41 includes a rail-like fulcrum receiving portion 52 extending in the front-rear direction. The fulcrum receiving portion 52 is in the form of a bead bent downward in an intermediate part in the front-rear direction of the base portion 45.

As shown in FIG. 2, the resilient contact portion 43 includes a contact point portion 53 having a semicircular shape curved downward in a side view. The lower end of the contact point portion 53 electrically contacts a conductive portion 101 (see FIG. 1) of the circuit board 100.

The protecting member 42 is in the form of a box, particularly a rectangular tube, as a whole and includes a front wall, an upper wall, a lower wall and a pair of side walls. A front part of the connecting member 41 is arranged inside the protecting member 42.

A lance hole 54 rectangular in a plan view is provided to be open in the upper wall of the protecting member 42 as shown in FIG. 11. Further, the upper wall of the protecting member 42 is provided with a locking projection 55 bent upward on the front edge of the lance hole 54. A front end part of the locking lance 14 enters the lance hole 54. As shown in FIG. 2, the locking projection 55 is locked by a front end part of the locking lance 14.

As shown in FIG. 11, the protecting member 42 includes an embossed fulcrum portion 56 projecting downward in a rear part of the upper wall. The fulcrum portion 56 is arranged to be displaceable in the front-rear direction in the fulcrum receiving portion 52.

The protecting member 42 includes holding portions 57 in rear parts of the both side walls. The holding portions 57 are arranged to sandwich the intermediate part in the front-rear direction of the connecting member 41 between the facing upper wall and the holding portions 57 (see FIG. 3). The intermediate part in the front-rear direction of the connecting member 41 is held between the holding portions 57 and the upper wall while being allowed to move.

The protecting member 42 includes a slope portion 58 inclined upward to the front at an intermediate position in the front-rear direction of the lower wall. As shown in FIG. 2, a front part of the lower wall in the protecting member 42 serves as an upper stage portion 59 arranged higher than a rear part of the lower wall via the slope portion 58. The upper stage portion 59 is provided with a connection hole 61 open in front of the slope portion 58. The circuit board 100 is arranged along the upper stage portion 59. The contact point portion 53 of the resilient contact portion 43 contacts the conductive portion 101 of the circuit board 100 through the connection hole 61 at the connection position.

<Retainer>

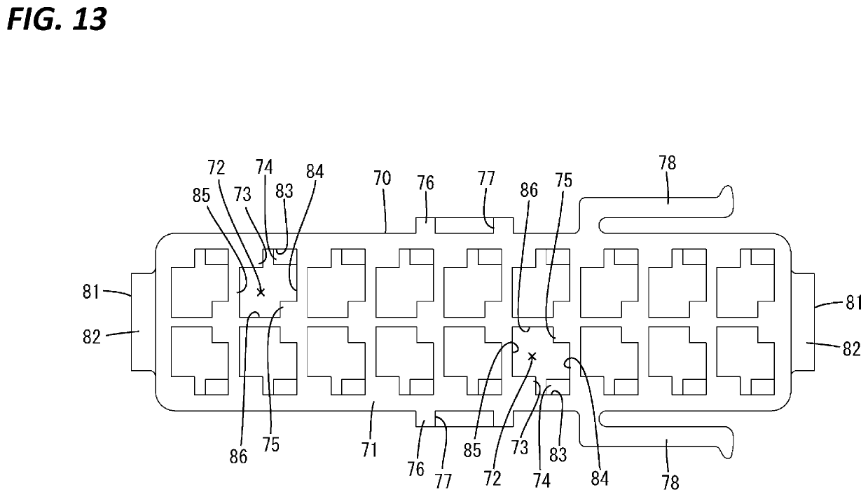

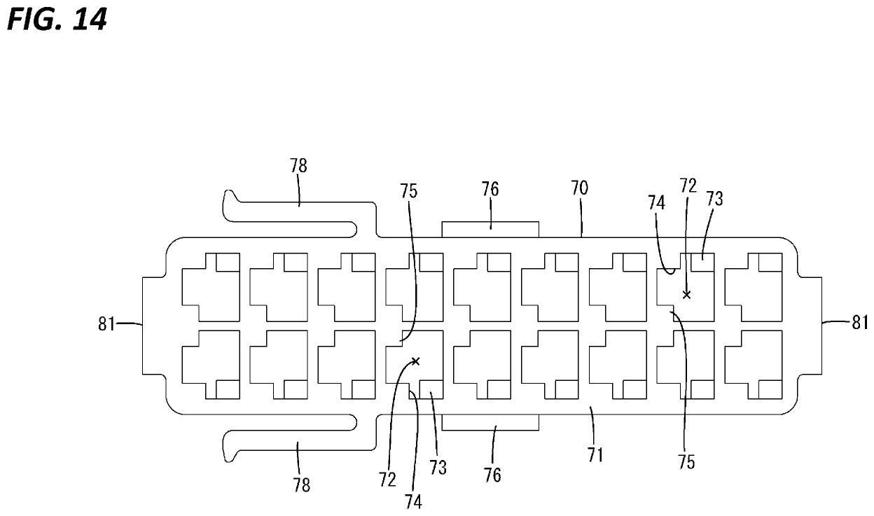

As shown in FIGS. 13 and 14, the retainer 70 includes a plate-like retainer body 71 having a rectangular shape long in the width direction in a front view. The retainer body 71 includes a plurality of through holes 72 at positions communicating with the respective rear cavities 23. As shown in FIG. 13, the retainer body 71 includes a front stop portion 73 and a rear stop portion 74 on an outer side 83 (one side away from a vertical center of the retainer body 71; an upper side of the through hole 72 in the upper stage, a lower side of the through hole 72 in the lower stage) in a rectangular opening edge of each through hole 72.

The rear stop portion 74 is in the form of a rectangular plate piece and so arranged that front and rear plate surfaces are along the vertical direction. The rear stop portion 74 projects over the outer side 83 and one side 84 adjacent via an outer corner (right upper corner of the through hole 72 in the upper stage, right lower corner of the through hole 72 in the lower stage in FIG. 13) on one widthwise side in the opening edge of the through hole 72. Further, the rear stop portion 74 is arranged in a rear end part of the through hole 72. The rear surface (rear plate surface) of the rear stop portion 74 is continuous and flush with the rear surface of a surrounding part of the retainer body 71.

Similarly to the rear stop portion 74, the front stop portion 73 is in the form of a rectangular plate piece and so arranged that front and front plate surfaces are along the vertical direction. The front stop portion 73 projects over the outer side 83 and another side 85 adjacent via an outer corner (left upper corner of the through hole 72 in the upper stage, left lower corner of the through hole 72 in the lower stage in FIG. 13) on the other widthwise side in the opening edge of the through hole 72. Further, the front stop portion 73 is arranged in a front end part of the through hole 72. The front surface (front plate surface) of the front stop portion 73 is continuous and flush with the front surface of a surrounding part of the retainer body 71.

A gap is formed in the width direction between the front stop portion 73 and the rear stop portion 74 in the through hole 72. As described later, the front stop portion 73 can stop the connecting member 41 in front. The rear stop portion 74 can stop the connecting member 41 in rear.

Further, the retainer body 71 includes a restricting portion 75 on an inner side 86 (one side near the vertical center of the retainer body 71: lower side of the through hole 72 in the upper stage, upper side of the through hole 72 in the lower stager) in the rectangular opening edge of each through hole 72 as shown in FIG. 13. The restricting portion 75 is arranged at a position diagonal to the front stop portion 73 in the through hole 72. The restricting portion 75 is in the form of a rib having a rectangular cross-section and provided over the entire length in the front-rear direction of the through hole 72.

The restricting portion 75 projects over the inner side 86 and the one side 84 adjacent via an inner corner (right lower corner of the through hole 72 in the upper stage, right upper corner of the through hole 72 in the lower stage in FIG. 13) on the one widthwise side in the opening edge of the through hole 72. As described later, the restricting portion 75 can retain the protecting member 42.

The retainer 70 includes a pair of the retaining portions 76 in widthwise central parts of the upper and lower edges of the retainer body 71. As shown in FIG. 1, the retaining portion 76 is gate-shaped in a plan view and projects rearward from the retainer body 71. The retaining portion 76 includes an engaging hole 77 open on a front end. The projection 31 of the outer housing 12 is inserted into the engaging hole 77 displaceably in the width direction (see FIGS. 5 and 6).

The retainer 70 includes a pair of upper and lower locking portions 78 each projecting from one widthwise side (right side of FIG. 13) of the upper or lower edge of the retainer body 71. Each locking portion 78 is cantilevered in the width direction in parallel to the upper and lower edges of the retainer body 71. The locking portions 78 are vertically deflectable and deformable with parts coupled to the upper and lower edges of the retainer body 71 as fulcrums. A tip part of the locking portion 78 is in the form of a claw projecting outward.

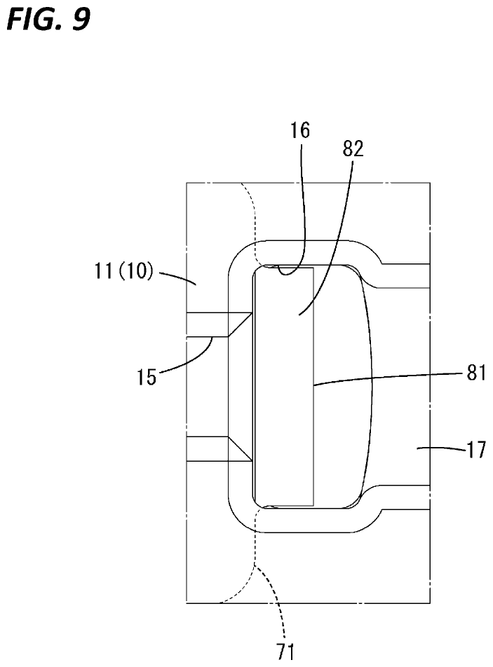

The retainer 70 includes a pair of cam portions 81 on both side edges (both widthwise side edges) of the retainer body 71. Each cam portion 81 is in the form of a rib extending in the vertical direction and projects in a vertically central part of the side edge of the retainer body 71. The front surface of the cam portion 81 serves as a cam surface 82 inclined rearward toward a widthwise outer side. As shown in FIG. 9, the cam surface 82 is arranged to be exposed to a front surface side of the housing 10 through the window portion 16 at the partial locking position.

<Assembling Structure of Connector>

Prior to the insertion of the terminal fitting 40 into the housing 10, the connecting member 41 is held at the protection position with respect to the protecting member 42. When the connecting member 41 is at the protection position, the contact point portion 53 abuts on the slope portion 58, thereby restricting a forward movement of the connecting member 41 with respect to the protecting member 42 (see FIG. 3). Further, when the connecting member 41 is at the protection position, the step portions 63 of the side portions 51 abut on the holding portions 57, thereby restricting a rearward movement of the connecting member 41 with respect to the protecting member 42. When the connecting member 41 is at the protection position, the contact point portion 53 of the resilient contact portion 43 is arranged to be protected inside the protecting member 42 behind the slope portion 58. Thus, the interference of external matters with the contact point portion 53 can be avoided.

The retainer 70 is arranged along the retainer mounting surface 28 with respect to the outer housing 12. The retaining portions 76 enter the space portions 29 of the outer housing 12 and the projections 31 of the outer housing 12 are inserted into the other widthwise sides of the engaging holes 77 of the retaining portions 76 (see FIG. 5). By the abutment of the projections 31 on the rear ends of the engaging holes 77 of the retaining portions 76, the retainer 70 is restricted from being separated forward from the retainer mounting surface 28 (see FIG. 3).

Further, after the locking portions 78 are deflected and deformed, tip parts of the locking portions 78 are inserted into the partial lock receiving portions 32 of the outer housing 12, whereby the retainer 70 is held at the partial locking position with respect to the outer housing 12 (see FIG. 5). When the retainer 70 is at the partial locking position, the through holes 72 communicate with the rear cavities 23 and the front stop portions 73 are arranged in insertion paths (passage paths when the connecting members 41 move) for the connecting members 41. Further, when the retainer 70 is at the partial locking position, the restricting portions 75 and the rear stop portions 74 are arranged to be retracted to the outside of the insertion paths for the connecting members 41. The front stop portion 73 covers an outer corner (left upper corner of the rear cavity 23 in the upper stage, left lower corner of the rear cavity 23 in the lower stage) on the other widthwise side of the rear cavity 23 at the partial locking position.

The inner housing 11 is inserted into the inner fitting portion 22 of the outer housing 12 and held at the initial position with respect to the outer housing 12 (see FIG. 3). When the inner housing 11 is at the initial position, the inner housing 11 is arranged in front of and away from the front surface of the retainer 70. The cam surface 82 of the cam portion 81 on one widthwise side is arranged to face the front surface side of the housing 10 through the window portion 16 (see FIG. 9).

Subsequently, the terminal fittings 40 are inserted into the housing 10 from behind. The terminal fittings 40 in the upper and lower stages are inserted in mutually vertically opposite postures into the housing 10 (terminal fittings 40 in the lower stage are not shown). The terminal fitting 40 in the upper stage is arranged with each projecting piece 48, 49 facing upward and the terminal fitting 40 in the lower stage is arranged with each projecting piece 48, 49 facing downward.

The protecting member 42 is inserted into the front cavity 13 through the insertion hole 23, the sealing hole 36 and the rear cavity 23. When the terminal fitting 40 is properly inserted into the housing 10, the locking projection 55 is locked by the locking lance 14 and the protecting member 42 is retained and held in the inner housing 11 as show in FIG. 3. The connection hole 61 of the protecting member 42 is arranged to communicate with the board insertion portion 15. Further, a rear part of the connecting member 41 on the side of the wire connecting portion 44 is arranged in the rear cavity 23 and a front part thereof on the side of the resilient contact portion 43 is arranged in the front cavity 13 together with the protecting member 42. The wire 30 is inserted into the sealing hole 36 in a liquid-tight manner and pulled out to outside through the insertion hole 27.

When the terminal fitting 40 is properly inserted into the housing 10, the front wall of the protecting member 42 is arranged to face a front surface portion 38 of the inner housing 11. Further, as shown in FIG. 7, the front end of the first projecting piece 48 is arranged to face the rear surface (rear plate surface) of the front stop portion 73.

In the case of this embodiment, even if a large forward pushing force is applied to the connecting member 41, the front end of the first projecting piece 48 abuts on the front stop portion 73, whereby the connecting member 41 is restricted from moving any further forward. Thus, the connecting member 41 is prevented from inadvertently moving from the protection position to the connection position.

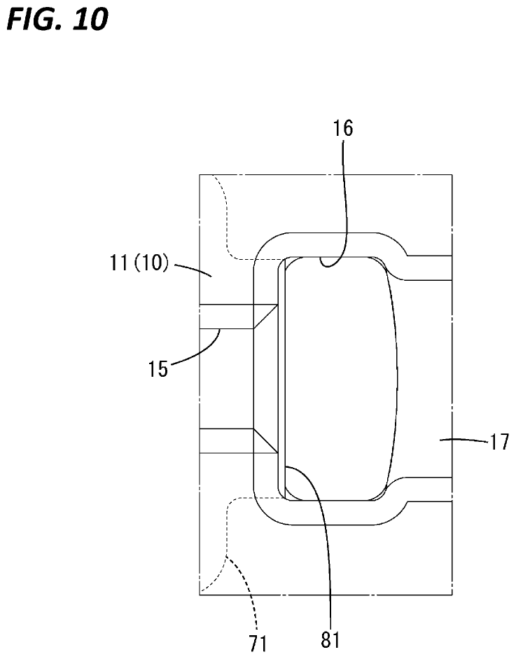

Prior to the connection of the housing 10 to the mating connector 90, the retainer 70 is moved from the partial locking position to the full locking position. At this time, an unillustrated rod-like jig is inserted into the window portion 16 on the one widthwise side. The tip of the jig is displaced rearward in the window portion 16 and abuts on the facing cam surface 82 from front. If the jig presses the cam surface 82, a moving force toward the other widthwise side (cam action force for translating a pressing force from front into a movement of the retainer 70 in the width direction) is applied to the cam portion 81 and the retainer 70 is moved from the partial locking position to the full locking position (see FIGS. 9 and 10).

In the process of moving the retainer 70 to the full locking position, the tip parts of the locking portions 78 come out from the partial lock receiving portions 32 and the locking portions 78 are deflected and deformed. When the retainer 70 reaches the full locking position, the locking portions 78 are resiliently restored and, as shown in FIG. 6, the tip parts of the locking portions 78 are inserted into the full lock receiving portions 33. In this way, the retainer 70 is held at the full locking position with respect to the outer housing 12.

The projections 31 of the outer housing 12 are displaced toward the one widthwise side in the engaging holes 77 of the retaining portions 76 in the process of moving the retainer 70 to the full locking position, and arranged on the one widthwise side in the engaging holes 77 of the retaining portions 76 when the retainer 70 reaches the full locking position.

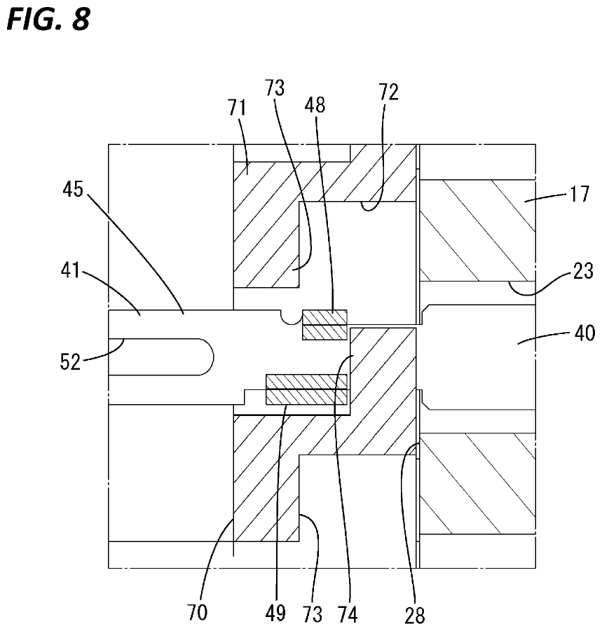

When the retainer 70 is at the full locking position, the front stop portion 73 is arranged away from the first projecting piece 48 toward the other widthwise side as shown in FIG. 8. Further, when the retainer 70 is at the full locking position, the front surface (front plate surface) of the rear stop portion 74 is arranged to face the rear end of the second projecting piece 49 and the rear end of a part (inner plate piece part, out of inner and outer place piece parts constituting the double plate structure of the first projecting piece 48) of the first projecting piece 48. Further, when the retainer 70 reaches the full locking position, the restricting portion 75 is arranged to face the protecting member 42 while being separated rearward from the protecting member 42 (see FIG. 4).

Subsequently, the housing 10 is connected to the mating housing 90. In this way, one end part of the circuit board 100 is inserted into the board insertion portion 15. Plate surfaces of the circuit board 100 are arranged along the width direction. Further, as the housing 10 is connected to the mating connector 90, a lock for holding the inner housing 11 and the outer housing 12 at the initial position is released and the outer housing 12 is enabled to move relatively forward with respect to the inner housing 11. As a connecting operation of the housing 10 proceeds, the inner housing 11 is deeply inserted into the inner fitting portion 19.

Here, the protecting member 42 is held in the inner housing 11 and the connecting member 41 is held in the outer housing 12. Further, since the front stop portion 73 is retracted to the outside of the passage path away from the first projecting piece 48 as described above, the connecting member 41 is allowed to be displaced forward with respect to the protecting member 42. Thus, if the outer housing 12 and the inner housing 11 relatively approach each other, the connecting member 41 and the protecting member 42 also relatively approach each other. In this way, the connecting member 41 is displaced from the protection position toward the connection position with respect to the protecting member.

In the process of moving the connecting member 41, the resilient contact portion 43 is deflected and deformed, the contact point portion 53 slides on the slope portion 58 and, further, the lower end of the contact point portion 53 temporarily rides on the upper stage portion 59. Then, the fulcrum portion 56 is relatively displaced from a front end side to a rear end side of the fulcrum receiving portion 52.

When the inner housing 11 reaches the fitting position with respect to the outer housing 12, the connecting member 41 also reaches the connection position (see FIG. 2). The contact point portion 53 falls down from the upper stage portion 59 and contacts the conductive portion 101 of the circuit board 100 through the connection hole 61 at the connection position. The resilient contact portion 43 is maintained in a deflected and deformed state.

Further, when the inner housing 11 reaches the fitting position with respect to the outer housing 12, the inner housing 11 is arranged to abut on the front surface of the retainer 70 as shown in FIG. 2. Then, the rear end of the protecting member 42 held in the inner housing 11 is arranged to face the front surface of the restricting portion 75.

Here, if a rearward pull-out force is applied to the terminal fitting 40 such as by the wire 30 being strongly pulled rearward, the second projecting piece 49 and a part of the first projecting piece 48 abut on the front surface of the rear stop portion 74, whereby the connecting member 41 is restricted from moving any further rearward. Further, by the abutment of the rear end of the protecting member 42 on the front surface of the restricting portion 75, the protecting member 42 is also restricted from moving any further rearward. Particularly, the protecting member 42 is doubly retained by the locking of the restricting portion 75 and the locking lance 14. Thus, with the terminal fitting 40 properly inserted in the housing 10, each of the connecting member 41 and the protecting member 42 is reliably restricted from moving rearward.

As described above, according to this embodiment, since the front stop portion 73 is provided in the retainer 70, the terminal fitting 40 can be stopped at an insertion position even if the front surface portion 38 of the inner housing 11 cannot ensure a sufficient strength and the like as a front stop structure for the terminal fitting 40. As a result, reliability in stopping the terminal fitting 40 at the insertion position can be enhanced.

In the case of this embodiment, when the retainer 70 is at the partial locking position, the front stop portion 73 restricts a forward movement of the terminal fitting 40. Further, when the retainer 70 is at the full locking position, the rear stop portion 74 restricts a rearward movement of the terminal fitting 40. Thus, a front stop state and a rear stop state of the terminal fitting 40 can be easily realized according to a displacement operation of the retainer 70.

When the retainer 70 is at the partial locking position, the connecting member 41 abuts on the front stop portion 73 at the protection position, whereby the connecting member 41 is restricted from moving forward with respect to the protecting member 42. Thus, a state where the connecting member 41 is protected by the protecting member 42 at the protection position can be satisfactorily realized.

Further, in the case of this embodiment, the cam portions 81 are provided on the retainer 70, the front surfaces of the cam portions 81 serve as the cam surfaces 82 facing in a direction inclined outward with respect to the front-rear direction and the cam surfaces 82 are arranged to be exposed to the front surface side of the housing 10 at the partial locking position. Thus, by inserting the jig through the window portion 16 from the front surface side of the housing 10, the cam surface 82 is pushed by the tip of the jig and the retainer 70 can be displaced toward the full locking position. Therefore, a complicated operation such as a two-stage operation needs not be performed in displacing the retainer 70 to the full locking position and workability can be improved.

### Other Embodiments

The embodiment disclosed this time should be considered illustrative in all aspects, rather than restrictive.

Although the terminal fitting is composed of the connecting member and the protecting member configured to be relatively displaced from each other in the case of the above embodiment, a terminal fitting may be composed of an inseparable single member as another embodiment.

Although the housing is composed of the inner housing and the outer housing in the case of the above embodiment, a housing may be composed of an inseparable single member as another embodiment.

Although the housing includes the front surface portion as the front stop structure for the terminal fittings in the case of the above embodiment, a housing may not include a front stop structure for terminal fittings as another embodiment.

### LIST OF REFERENCE NUMERALS

1 connector
10 housing
11 inner housing
12 outer housing
13 front cavity
14 locking lance
15 board insertion portion
16 window portion
17 housing body
18 fitting tube portion
19 inner tube portion
20 sealing ring
21 lock arm
22 inner fitting portion
23 rear cavity
24 one-piece rubber plug
25 accommodating portion
26 rear holder
27 insertion hole
28 retainer mounting surface
29 space portion
30 wire
31 projection
32 partial lock receiving portion
33 full lock receiving portion
34 recess
36 sealing hole
38 front surface portion
40 terminal fitting
41 connecting member
42 protecting member
43 resilient contact portion
44 wire connecting portion
45 base portion
46 wire barrel portion
47 insulation barrel portion
48 first projecting piece
49 second projecting piece
51 side portion
52 fulcrum receiving portion
53 contact point portion
54 lance hole
55 locking projection
56 fulcrum portion
57 holding portion
58 slope portion
59 upper stage portion
61 connection hole
63 step portion
70 retainer
71 retainer body
72 through hole
73 front stop portion
74 rear stop portion
75 restricting portion
76 retaining portion
77 engaging hole
78 locking portion
81 cam portion
82 cam surface
83 outer side
84 one side
85 other side
86 inner side
90 mating connector
91 receptacle
100 circuit board
101 conductive portion

1. A connector, comprising:
a terminal fitting;
a housing configured such that the terminal fitting is inserted thereinto; and
a retainer to be mounted into the housing,
the retainer including a rear stop portion for restricting a rearward movement of the terminal fitting and a front stop portion for restricting a forward movement of the terminal fitting, and
the terminal fitting including a projecting piece, a front end of the projecting piece being arranged along a vertical direction, a rear surface of the front stop portion being arranged along the vertical direction, the front end of the projecting piece being arranged to face and abut on a rear surface of the front stop portion.

2. The connector of claim 1, wherein:
the retainer is displaceable to a partial locking position and a full locking position with respect to the housing,
the rear stop portion restricts a rearward movement of the terminal fitting at the full locking position, and
the front stop portion restricts a forward movement of the terminal fitting at the partial locking position.

3. A connector, comprising:
a terminal fitting;
a housing configured such that the terminal fitting is inserted thereinto; and
a retainer to be mounted into the housing,
the retainer being displaceable to a partial locking position and a full locking position with respect to the housing,
the retainer including a rear stop portion for restricting a rearward movement of the terminal fitting at the full locking position and a front stop portion for restricting a forward movement of the terminal fitting at the partial locking position,
the terminal fitting including a connecting member and a protecting member,
the connecting member being displaceable with respect to the protecting member to a protection position where the connecting member is protected by the protecting member and a connection position where the connecting member is connected to a circuit board, the connection position being forward of the protection position, and
the connecting member being configured to abut on the front stop portion at the protection position when the retainer is at the partial locking position.

4. The connector of claim 2, wherein:
the retainer has a cam surface inclined with respect to a front-rear direction on a front surface side, and
the cam surface is arranged to be exposed to a front surface side of the housing at the partial locking position.

5. The connector of claim 1, wherein the housing includes a locking lance for resiliently locking and retaining the terminal fitting.
